(19) United States
(12) Patent Application Publication
(10) Pub. No.: US 2020/0279554 A1
(43) Pub. Date: Sep. 3, 2020

(54) SYSTEM AND METHODS FOR PERFORMING SEMANTICAL ANALYSIS, GENERATING CONTEXTUALLY RELEVANT, AND TOPIC BASED CONVERSATIONAL STORYTELLING

(71) Applicants: Marc Aaron Canter, Walnut Creek, CA (US); Stephen Richard DiPaola, North Vancouver (CA); Nazim Mir, Bengaluru (IN)

(72) Inventors: Marc Aaron Canter, Walnut Creek, CA (US); Stephen Richard DiPaola, North Vancouver (CA); Nazim Mir, Bengaluru (IN)

(21) Appl. No.: 16/804,279

(22) Filed: Feb. 28, 2020

Related U.S. Application Data
(60) Provisional application No. 62/811,593, filed on Feb. 28, 2019.

(51) Int. Cl. G10L 15/18; G06N 5/02; G10L 15/22; G10L 15/30

(52) U.S. Cl. CPC G10L 15/1815; G10L 15/30; G10L 15/22; G06N 5/02

(57) ABSTRACT

Exemplary embodiments of the present disclosure are directed towards a system for performing semantical analysis, generating contextually relevant, and topic based conversational storytelling through natural language processing techniques, comprising: a hybrid conversational storytelling system comprising an instigate artificial intelligence conversation management module, a topic managing module, a context managing module, an internal conversation engine, and external conversation engines, the instigate artificial intelligence conversation management module is configured to execute scripts, orchestrates media sequences within a conversation and analyse an input content received from a computing device, the instigate artificial intelligence conversation management module comprising a pre-processing module configured to interpret the input content and check whitelists to generate a conversational storytelling script from an internal conversation engine and the external conversation engines on the computing device, the instigate artificial intelligence conversation management module is configured to transmit the conversational storytelling script generated from the of the internal conversation engine and the external conversation engines to a post-processing module, the post-processing module is configured to aggregate the conversational storytelling script with a generative storytelling engine and a media content to generate a media-based conversational storytelling script on the computing device, the conversational storytelling script is generated from one of the internal conversation engine and the plurality of external conversation engines.

### CROSS-REFERENCE TO RELATED APPLICATIONS

This patent application claims the benefit of U.S. Provisional Patent Application No. 62/811,593, filed 28 Feb. 2019, entitled “SYSTEM AND METHODS EMPLOYED FOR TARGETED INTERPRETATION AND RESPONSE GENERATION”, which is incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter generally relates to computer programs configured for targeted interactive data processing and communication. More particularly, the present disclosure relates to system and methods for performing semantical analysis, generating contextually relevant, and topic based conversational storytelling through natural language processing techniques.

### BACKGROUND

Natural language processing systems such as machine translation, speech recognition, voice synthesis systems or messaging based systems typically operate based on the words stored in a data repository to enable linguistic communication. The natural language processing system takes an end user's voice or text input and interprets the meaning of words spoken by the end-user. Thus, the end-user referred to in the present disclosure as an “Interactor”, becomes an integral part of the natural language processing system's capabilities.

The main objective of the natural language processing systems is to understand what the Interactor is trying to communicate and request. Most of the present and past artificial intelligence research is focused on the methods to understand human languages. But, said research has failed to produce significant value as the “net” cast by such research projects is too wide, e.g., attempting to solve for multiple languages, multiple accents, and multiple domains all at the same time. In a natural language processing setting, the conversations with each Interactor is different, which makes the interpretation and generation of targeted responses for each different Interactor's conversation a challenging task. Existing systems cannot optimize to work with existing natural language processing systems. Existing systems do not intercept on a case by case basis, judge each word, key phrase or statement on its own.

In the light of aforementioned discussion, there exists a need to perform semantical analysis, generates a contextually relevant, topic based conversation storytelling (hybrid conversational storytelling system), the hybrid conversational storytelling system includes storytelling creation and playback module, conversation management module and orchestrator, a swappable narrow domain internal conversation engine, a topic manging module, and a context managing module with novel methodologies that would overcome the above-mentioned challenges.

### SUMMARY

The present invention overcomes shortfalls in the related art by presenting an unobvious unique combination and configuration of methods and components to perform semantical analysis, generate a contextual relevant, topic based conversation storytelling, the hybrid conversational storytelling system includes storytelling creation and playback module, conversation management module and orchestrator, a swappable narrow domain internal conversation engine, and topic and context managing module with novel methodologies that would overcome the above-mentioned challenges.

In one embodiment of the present invention, a system includes a hybrid conversational storytelling system configured to focus on a single domain of knowledge and build a huge vocabulary of topics, language and vernacular around said domain.

An exemplary objective of the present disclosure is directed towards intercepting conversational flow and inserting second user's language within the context of the conversation.

Another exemplary objective of the present disclosure is directed towards facilitating the first users to select one of the internal conversation engine and the external conversation engine to insert their own language at any point in a Being's scripted conversation.

An exemplary objective of the present disclosure is directed towards achieving a narrow natural language processing system that is based upon a technique i.e., constrained language approach. In this regard, in addition to simply informing users of the system constraints, humour is also utilized to highlight but minimize said limitations, the narrow natural language processing system provides certain kinds of story structures (opener, ending, branches, and menus).

Yet another exemplary objective of the present disclosure is directed towards attempting to interpret certain domain specific areas of language and ignore anything out of the scope of that narrow focus.

Yet another exemplary objective of the present disclosure is directed towards determining the intersection with domain data by the instigate artificial intelligence conversation management module.

Yet another exemplary objective of the present disclosure is directed towards maintaining the conversation flow by providing “natural” responses from the external conversation engine to inquiry catered towards a specific domain area.

Yet another exemplary objective of the present disclosure is directed towards making the conversation engines smarter by establishing patterns of behaviour that remember what answers and responses it has received from the various text and interactive input controls it has shown to the Interactor.

An exemplary aspect of the present disclosure is directed towards, a hybrid conversational storytelling system comprising an instigate artificial intelligence conversation management module, a topic managing module, a context managing module, an internal conversation engine, and a plurality of external conversation engines

Another exemplary aspect of the present disclosure is directed towards, the instigate artificial intelligence conversation management module that is configured to execute a plurality of scripts, orchestrates media sequences within a conversation and analyzes an input content that has been received from a computing device.

Another exemplary aspect of the present disclosure is directed towards, the instigate artificial intelligence conversation management module comprising a pre-processing module configured to interpret the input content and check a plurality of whitelists to generate a conversational storytelling script from at least one of an internal conversation engine and the plurality of external conversation engines on the computing device.

Another exemplary aspect of the present disclosure is directed towards, the instigate artificial intelligence conversation management module that transmits the conversational storytelling script generated from either the internal conversation engine or from one of the external conversation engines to a post-processing module.

Another exemplary aspect of the present disclosure is directed towards, the post-processing module is configured to aggregate the conversational storytelling script with a generative storytelling engine and a media content to generate a media-based conversational storytelling script on the computing device. Where the conversational storytelling script is generated from at least one of the internal conversation engine and the plurality of external conversation engines.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram representing an example environment in which aspects of the present disclosure can be implemented.

FIG. 2 is a block diagram depicting an embodiment of the hybrid conversational storytelling system 101, in accordance with one or more exemplary embodiments.

FIG. 3A is a block diagram depicting another embodiment of the hybrid conversational storytelling system 101, in accordance with one or more exemplary embodiments.

FIG. 3B is a block diagram depicting the instigate artificial intelligence conversation management module, in accordance with one or more exemplary embodiments.

FIG. 4 is a flow diagram depicting a method for processing input content to generate output response, in accordance with one or more exemplary embodiments.

FIG. 5 is a flow diagram depicting a method for interpreting Interactor's conversation sequence and generating a response, in accordance with one or more exemplary embodiments.

FIG. 6 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

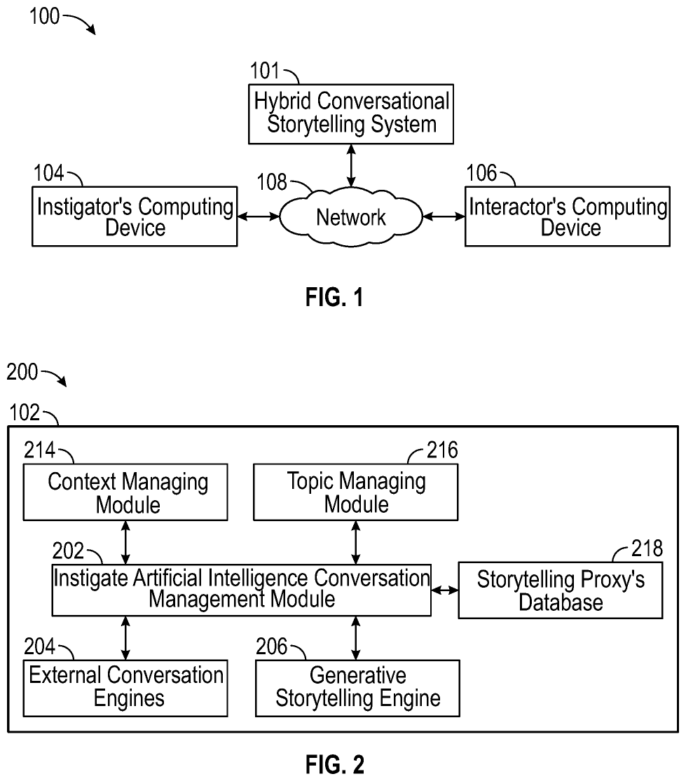

Referring to FIG. 1, FIG. 1 is a block diagram 100 representing an example environment in which aspects of the present disclosure can be implemented. Specifically, FIG. 1 depicts a schematic representation of system 100 for performing semantical analysis, generating contextually relevant, and topic based conversational storytelling through natural language processing techniques. The system 100 includes a hybrid conversational storytelling system 101, an Instigator's computing device 104, an Interactor's computing device 106, and a network 108. The generated response may include, but not limited to, a storytelling conversation script, a media-based storytelling conversation script, and so forth.

The network 108 may include, but not limited to, an Ethernet, a wireless local area network (WLAN), or a wide area network (WAN), a WIFI communication network e.g., the wireless high-speed internet, or a combination of networks. The network 108 may provide a web interface employing transmission control protocol, hypertext transfer protocol, simple object access protocol or any other internet communication protocol. Each of the computing devices 104, 106 represents a system such as a personal computer, workstation, mobile station, mobile phones, computing tablets, etc. When the computing devices 104-106 correspond to mobile devices (e.g., mobile phones, tablets, etc.), and the applications (a hybrid conversational storytelling system 101) accessed are mobile applications, software that offers the functionality of accessing mobile applications, and viewing/processing of interactive pages, for example, is implemented in the computing devices 104-106, as will be apparent to one skilled in the relevant arts by reading the disclosure provided herein.

The systems of FIG. 1 may be implemented in a traditional client-server setup or on a cloud setup. Cloud represents a conglomeration of computing and storage systems, in combination with associated infrastructure (including networking/communication technologies, resource management/allocation technologies, etc.) such that the available computing, storage, and communication resources are potentially dynamically allocated to processing of various requests from client systems (e.g., 104-106). Should the systems of FIG. 1 be implemented as shown, while the systems are shown with three components merely for conciseness, it may be readily appreciated that when implemented on a cloud, the systems of FIG. 1 may contain many more servers/systems, potentially in the order of thousands. The computing and storage systems may also be coupled based on IP protocol, though the corresponding connectivity is not shown in FIG. 1.

The hybrid conversational storytelling system 101 may be attempted to interpret and understand everything an Instigator or Interactor types from the computing devices 104-106. The computing device may include but not limited to Instigator's computing device and Interactor's computing device etc. An Instigator, for instance, is an author who creates interactive narratives (stories/scripts) and creates topics that build a backstory (i.e., a background) and a knowledge base for a Being, to provide for various levels of interactivity with an Interactor, i.e., a user. Instigators are uniquely allowed to create and interact with the content in a simultaneous fashion. The hybrid conversational storytelling system 101 may be configured to focus on a single domain of knowledge and build a huge vocabulary of topics, and authentic language structure, sayings, phrases, and vernacular around the domain.

The hybrid conversational storytelling system 101 may be configured to enable the on-going conversation to utilize memory and a context to keep the conversation relevant and compelling. The hybrid conversational storytelling system 101 may also be configured to understand time, day, and where the conversation is taking place, who the Interactor is, and earlier history of the interactions with the Interactor. The hybrid conversational storytelling system 101 may be configured to receive an input content from the responses and interactions of the Interactors and feed the input content back into itself to create a recursive learning loop. The input content may include, but not limited to, videos, images, audio, text, voice content, and so forth.

For example, the hybrid conversational storytelling system 101 is configured to bring cognitively indexed and understood language to bear in storytelling, promoting an idea or item, lauding a colleague or selling just about anything, and the like. The hybrid conversational storytelling system 101 may also be configured to manipulate and synthesize the conversation to interact with the Interactors in a myriad of fashions, contexts, use case scenarios, and the like. The hybrid conversational storytelling system 101 may be configured to give the response at the right time, and further configured to provide a logical, humorous or personal response to the Interactors. The hybrid conversational storytelling system 101 may be configured to add relevant concepts, events, people, places and things into the conversation. The hybrid conversational storytelling system 101 may take one gesture of the data, flip it and flop it in all sorts of ways. The hybrid conversational storytelling system 101 may be configured to immerse a certain domain of knowledge or culture to entertain the conversation flow with the Interactors.

The hybrid conversational storytelling system 101 may be configured to focus on specific knowledge surrounding a particular domain area of the knowledge. For example, the hybrid conversational storytelling system 101 enables the Interactors to choose from makeup, gaming or cars, and associate personal Being with one of those domain areas. For example, if the Interactor converses with a car Being, they may talk about “reviving up their engines” or “zooming down the street” while a Makeup Being may converse about “working on your contour” or “making your wings zing”.

In this regard, the hybrid conversational storytelling system 101 is based upon a constrained approach to language. The goal of the said system is that if a conversation can be limited to a certain domain, users can experience a fulfilling conversation without having to “stray” outside the constraints. The users may include, but not limited to, instigators, interactors, and the like. To achieve this end, the main technique utilized in said system is to simply inform the user of the constraints of the hybrid conversational storytelling system 101. For example, Interactors receive a message such as the following: “This Being knows nothing about anything BUT MakeUp. She's an expert at MakeUp, can tell you all about the techniques, vendors, influencers, and trends—regarding MakeUp—but that's it. REPEAT: This Being knows NOTHING about ANYTHING BUT MAKEUP.

Please restrict all questions and discourse to that regarding MakeUp.”

In an embodiment of the present disclosure, in addition to simply informing Interactors of the constraints of the system, i.e., the “narrowness” of the hybrid conversational storytelling system 101—humour is also utilized to highlight but minimize said limitations. For example, if an Interactor is interacting with a Makeup Being, and the Interactor attempted to move the conversation to a discussion around automobiles, the hybrid conversational storytelling system 101 could respond as thus: “Yo! Remember the constraint thing? Since I'm a Being I can get very specific about what I do and don't know. And [xxxxxwhatever was typedxxxxx] is NOT anything I know about!”. Alternatively, the system 101 may also respond with: “OMG—I can't believe you strayed! Being a narrow NLP based Being means I'm as dumb as all the other Beings—when it comes to [xxxxxwhatever was typedxxxxx]-please restrict your communicating to something that I can understand—like MakeUp!”.

The hybrid conversational storytelling system 101 may also be configured to provide required data to propagate a complete profile of the Storytelling Being and also to sculpt and craft the Storytelling Being's personality. The hybrid conversational storytelling system 101 may be configured to utilize particular answers and specific contexts to expand the quality of Being's stories and range of Being's personality.

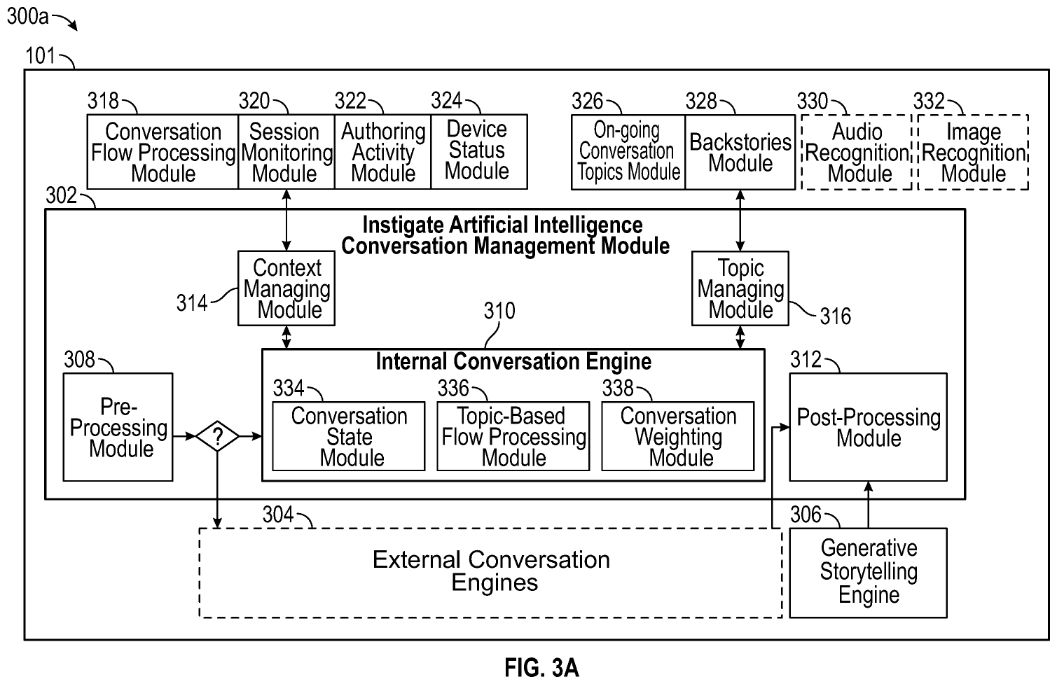

Referring to FIG. 2, FIG. 2 is a block diagram depicting an embodiment of the hybrid conversational storytelling system 101, in accordance with one or more exemplary embodiments. The hybrid conversational storytelling system 101 includes an instigate artificial intelligence conversation management module 202, external conversation engines 204, a generative storytelling engine 206, a context managing module 214, and a topic managing module 216, and a storytelling proxy database 218. The instigate artificial intelligence conversation management module 202 may be configured to execute scripts, orchestrates media sequences within the conversation and parses the Instigators or Interactors text input. The instigate artificial intelligence conversation management module 202 may be configured to coordinate media, scripted text with Interactor's response. The external conversation engines 204 may be a “topic” based sub-system and is capable of running on top of many different native natural language processing systems; both voice activated as well as text-based messaging systems. The external conversation engines 204 (voice activated as well as text-based messaging systems) may include, but not limited to, Alexa, Google Asst, Bixby, Cortana, Hugging Face, Rasa, and the like.

The context managing module 214 and the topic managing module 216 may be configured to feed and connect the current conversations into the instigate artificial intelligence conversation management module 202. The topic managing module 216 may be a centralized repository and a manager for a Being's “topics” which are utilized throughout the system. The topics extracted from the transcription text may be used to develop some of the topics that the topic managing module 216 receives. Topics from on-going conversations are another source of Topics. Topics from (future) image recognition software may also be a valuable source of topics for the topic managing module 216. The topics representing and derived from the Being “backstories” may be the major topics utilized by the topic managing module 216. The topic managing module 216 may be configured to collect the topics and feeds them to various kinds of semantic encoding and analysis software (both our internal conversation engine and external conversation engines.) The internal conversation engine and external conversation engines may be utilized to both influence and define language which makes up a Being's “personality” and language.

The context managing module 214 may be considered the past, present and future “contexts” which are important to define how and why the Being will interact, react and speak. The various “states” of the system to feed and support the context managing module 214 may include, but not limited to, the conversation itself (what is being said, by who), session monitoring of the user interacting in the conversation (status), any authoring or creation activity by the Creator, any motion, geo location or other contextual info from the computing devices 104, 106. The combination of the topic and context managing modules 214, 216 may be configured to extract the meta-data information (topics) from the Instigators' input content. The storytelling proxy's database 218 may be a database of knowledge graphs and meaning associated with unique storytelling proxies. The storytelling proxy's database 218 may be a collection of semantically encoded media, text, ideas and “information” that may be associated with other media and text to create the “illusion” of the storytelling proxy “being alive.” Every storytelling proxy in the storytelling proxy's database 218 has an associated knowledge graph of content, metadata, relationships, and semantics. The knowledge graph of information comes directly from the Instigator authoring storytelling proxies, crafting stories, creating and uploading media, mentioning keywords and topics, building whitelists and from the Interactors who interact with the storytelling proxy.

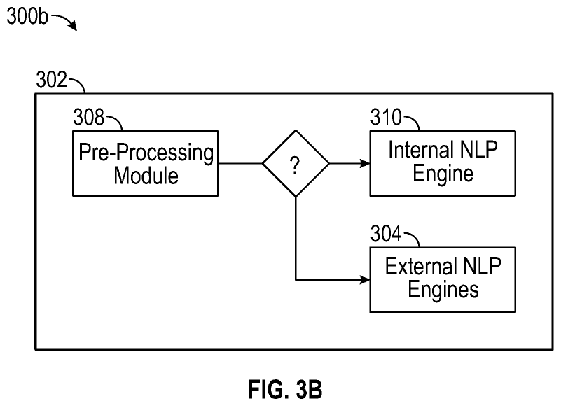

The external conversation engines 204 may be a matrix of real-time language retrieval and dynamic response generation engines that collectively create the effect of narrow natural language processing. The instigate artificial intelligence conversation management module 202 may be configured to swap between the external conversation engines to create the “narrow NLP” effect. The external conversation engines 204 may be configured to access its unique data, which is specifically designed for meeting requirements and performance criteria. Overall, the hybrid conversational storytelling system 101 may be configured such that creating, consuming, scraping, editing, cleansing or otherwise managing the data is fully controlled within the hybrid conversational storytelling system 101. The instigate artificial intelligence conversation management module 202 may be configured to switch between different language parsing, storytelling and other kinds of natural language processing sub-systems. The instigate artificial intelligence conversation management module 202 utilizes the carrier/telecom industry messaging protocol for communicating to external natural language processing systems. The carrier/telecom industry messaging protocol may include rich communication services. The instigate artificial intelligence conversation management module 202 is configured to utilize the rich communication service messaging protocol to communicate each message from the internal conversation engines 310 (shown in FIG. 3) and/or the external conversation engines 304 (shown in FIG. 3).

The instigate artificial intelligence conversation management module 202 may include combination of interpreting an input content (for example incoming conversational element) and checking whitelists to generate a conversational storytelling script from the internal conversation engine, in case we “don't want it”, and then post-processing all language elements generated from the external conversation engines 204 on the computing devices 104, 106 and binding media content and special effects to that language may then be rendered as part of a media-based conversational storytelling experience. The instigate artificial intelligence conversation management module 202 may be configured to integrate an internal conversation engine (shown in FIG. 3, 310) into the conversational storytelling environment and context.

The external conversation engines 204 may be configured to interpret the language and dynamic generation of appropriate responses. The external conversation engines 204 may be configured to provide dynamic language (for example, sentences, phrases) that may be directly associated with the specific domain and focus on a vernacular of particular domain and specific knowledge surrounding to a particular domain area of knowledge, i.e., a knowledge “base”. The external conversation engines 204 may be configured to provide the functionality to swap in pre-built sentences (which gets displayed at the appropriate time) and responses. The external conversation engines 204 may be configured to dynamically construct the sentences, which are dictated by the context. Furthermore, the external conversation engines 204 are configured to contribute topic comebacks, snarky quips, to specialize in sentence transitions, segues, tangential jumps, and the like.

The instigate artificial intelligence conversation management module 202 may be configured to swap between external conversation engines 204, interrupt routines, segue to different topics and return, and the like. Collectively the effect of producing a narrowly focused, narrow natural language processing is what the instigate artificial intelligence conversation management module 202 is responsible for implementing. The instigate artificial intelligence conversation management module 202 may be configured to act as an orchestrator or scheduler for the conversations as well as a meta-language for creating the narrow natural language processing effect. The instigate artificial intelligence conversation management module 202 may be configured to control the external conversation engines 204. The instigate artificial intelligence conversation management module 202 may also be configured to control the conversations. For example, the conversations may be based on one story backbone that has a beginning, middle or ending, and the like. The story may lead the Interactor through a foreground set of topic-based content, while various forms of media content, conversation, and interaction that interrupts the story flow. The instigate artificial intelligence conversation management module 202 may be configured to strike a balance between free-flowing interpretation, predefined storylines, various kinds of media effects, and the like. The generative storytelling engine 206 may be configured to generate text paragraphs or conversations based on a pre-defined corpus of content. The text output of the generative storytelling module 206 configured to combine with the Instigator's scripted text and media content.

As described above with reference to FIG. 1, the Instigators may be uniquely allowed to create and interact with the content in simultaneously fashion. Similarly, the Interactors may also be enabled to interact with the content in a simultaneous fashion. Specifically, information and knowledge of the Interactor's and the Instigator's beliefs, preferences, opinions, and self may be garnered from the various “answers” that have been collected from the responding to questions and answers. This knowledge may be woven into the foreground stories and background information. From this perspective, it is pertinent to note that one of the unique objectives and advantages of the present disclosure is the ability of the Interactor to utilize all of the foreground and background information simultaneously. That is, the stories the hybrid conversational storytelling system 101 tells are in the foreground, and the answers culled from the questions are peppered throughout the conversation, and the backstory is utilized in the background, and the hybrid conversational storytelling system 101 is utilized to join it all together and be implemented simultaneously.

Referring to FIG. 3A, FIG. 3A is a block diagram depicting another embodiment of the hybrid conversational storytelling system 101, in accordance with one or more exemplary embodiments. The hybrid conversational storytelling system 101 includes the instigate artificial intelligence conversation management module 302, and the external conversation engines 304, and a generative storytelling engine 306. The instigate artificial intelligence conversation management module 302 includes a pre-processing module 308, the internal conversation engine 310, a post-processing module 312, a context managing module 314, and a topic managing module 316. The internal conversation engine 310 may include an internal natural language processing (NLP) engine and the external conversation engines 304 may include external natural language processing (NLP) engines. The external conversation engines 304 (voice activated as well as text-based messaging systems) may include, but not limited to, Alexa, Google Asst, Bixby, Cortana, Hugging Face, Rasa, and the like. The pre-processing module 308 may be configured to check each and every input content that the user has typed and routes that input content to one of the internal conversation engine 310 and the external conversation engines 304. The instigate artificial intelligence conversation management module 302 may be configured to receive the input responses of the Instigator/Interactor conversation and are parsed by the pre-processing module 308. The pre-processing module 308 may be configured to allow the instigate artificial intelligence conversation management module 302 to check whitelists, insert in various story elements, or current status and other “contextual (adaptive) rules.” The whitelists may include, but not limited to, a list of keywords, text, media responses associated with the keyword. The media response may include, but not limited to, video response, music response, image response, sound response, narration and the like. The pre-processing module 308 may be configured to decide whether the internal conversation engine 310 may process the response or whether the external conversation engines 304 are to be utilized. The internal conversation engine 310 may be an instigate artificial intelligence natural language processing engine. The generative storytelling engine 306 may be configured to generate text paragraphs or conversations based on the pre-defined corpus of content. The text output of the generative storytelling module 206 may be configured to combine with the Instigator's scripted text and media content. The generative storytelling engine 306 may be the artificial intelligence technique that synthetically creates paragraphs of descriptive narrative text. Source statements may be utilized to generate the descriptive narrative text, which is then aggregated and included in the Being's script. The Instigator may insert generated text into a Being's script, just as they insert media elements of special EFX.

The internal conversation engine 310 may be configured to control many factors of the Being's personality and conversational capabilities. The conversational capabilities may include, but not limited to, customized fall-backs, cross-platform (voice and messaging) conversations, adaptive contextually driven interactivity, scalable content, and the like. The internal conversation engine 310 may be a topic-based and is implemented by an artificial intelligence authoring paradigm. The artificial intelligence authoring paradigm may be based on topics. The authoring is based on the principle in which an author “trains” the Being by inputting and defining topics into the system 100 through various means. The internal conversation engine 310 may be configured to analyse the Instigator's input and considers the current state and the current conversation of the Instigator's. The internal conversation engine 310 may be configured to weigh all the potential answers and responses to the Instigator's input to display (what it believes to be) the best response and sends that response to the Interactor's computing device 106. The unique implementation of the internal conversation engine 310 considers many nuances, contrarian trends and realistic designs necessary for a successful natural language processing engine in today's consumer online digital marketplace. The internal conversation engine 310 may be configured to work with either text-based messaging input or via voice-activated input which means the internal conversation engine 310 may work in the home in a cross-platform deployment model. The cross-platform deployment model may include, but not limited to voice and mobile devices, smartphones, laptops, desktop machines, automobiles, gaming consoles or kiosks.

The internal conversation engine 310 may be configured to determine the best response and the response may be transmitted to the post-processing module 312. The post-processing module 312 may be configured to receive the response from the internal conversation engine 310 to optimize the conversation by adding the scripted media elements to the response. The post-processing module 312 may be configured to aggregate the conversational storytelling script with a generative storytelling engine and a media content to generate the media-based conversational storytelling script on the computing devices 104, 106. The conversational storytelling script may be generated either from the internal conversation engine 310 or the external conversation engines 304.

The context managing module 314 and the topic managing module 316 may be configured to feed and connect the current conversations into the instigate artificial intelligence conversation management module 302. The context managing module 314 may include a conversation flow processing module 318, a session monitoring module 320, an authoring activity module 322, and a device status module 324. The conversation flow processing module 318 may be configured to track the status of current conversation. The status of current conversation may include, but not limited to, what was just said, the Being's backstory, semantics, current status, and so forth. The session monitoring module 320 may be configured to monitor, log and keep track of the Instigator's and Interactor's instructions. The instructions may include, but not limited to, pause time, how long rate of interaction help or not, and so forth. The session monitoring module 320 may also be configured to generate contextual relevant alerts and notifications to the Instigator's computing device 104 and the Interactor's computing device 106. The authoring activity module 322 may be configured to enable the Instigators and Interactors to create, edit and test the conversation on the Instigator's computing device 104 and the Interactor's computing device 106. The device status module 324 may be configured to identify the status of the devices 104 and 106. The device status may include, but not limited to, geolocation, temperature, time of the day, and so forth.

The topic managing module 316 may be configured to collect, aggregate and support building semantically encoded storytelling Being. The topic managing module 316 may include an on-going conversation topics module 326, a backstories module 328, an audio recognition module 330, and an image recognition module 332. The on-going conversation topics module 326 may be configured to track the topics in the conversations of the Instigator and the Interactor. The backstories module 328 may be configured to track the backstories in the topics. The backstories may include, but not limited to, people, places, things, events, and so forth. The audio recognizing module 330 may be configured to recognize the audio from the videos, audio text, text statements, music, memes, and so forth. The audio recognizing module 330 may also be configured to digitize and transcribe the speech into text so that the topics may be extracted from the Instigator or Interactor's spoken text. The topics may include, but not limited to, movies, sports, celebrities, sportspersons, actors, actress, singers, and so forth. The extracted text and the transcribed text may be utilized as overlay text and text statements within the script. The image recognition module 332 may be configured to identify, label, output topics that reside within the visual frame of the media content on the Instigator's computing device 104 and/or the Interactor's computing device 106. For example, the image recognition module 332 is configured to encode and analyse the objects, scenes, context included in the media content. The image recognition module 332 may be configured to identify and encode the images from the media content (for example, videos, images, real-time videos, selfies, audio files, voice content, etc).

The internal conversation engine 310 includes a conversation state module 334, a topic-based flow processing module 336, and a conversation weighting module 338. The conversation state module 334 may be configured to identify the state of the Instigator's or Interactor's brain after providing input through text-based messaging input or via voice-activated input from the Instigator's computing device 104 or the Interactor's computing device 106. The conversation state module 334 may also be configured to optimize real-time conversations on the Instigator's computing device 104 and the Interactor's computing device 106. The conversation state module 334 may also be configured to keep track of all the relevant and topic-based attributes of the hybrid conversational storytelling system 101. The attributes may include, but not limited to, conversation attribute, story attribute, pedagogy attribute, awareness attribute, and so forth. The conversation attribute may include the status of the current conversation such as saying what, any tangential jumps, pending questions, resolve, and so forth. The story attribute may include where the storytelling Being is in the current stories progress. The story attribute playback-head location. The story attribute may keep track of other narrative structures like the hero (protagonist), the villain (antagonist), conflicts, goals, talisman, and McGuffins. The pedagogy attribute may include where the storytelling Being is in its “learning curve” or educational process. The pedagogy attribute is relevant when the storytelling proxies are used in conjunction with educational or training scenarios. The awareness attribute may include what the Being “feels”, how many times it's been interrupted if there is any motion or place being considered, and its overall emotional status. The topic-based flow processing module 336 may be configured to focus on all responses and interactions around a single or paired topic. The topic-based flow processing module 336 may also be configured to direct the conversation to various kinds of “fall-backs” and “depth node levels”. The internal conversation engine 310 may be configured to support multiple “levels” of fall-backs, which may be contextually driven and customized for any storytelling Being. The fall-backs are where a conversation is sent to—if no “good” answer or response has been identified. The depth nodes may be engaged during the transition when a conversation is veered away from its current topic, different kinds of jumps, segues, non-sequiturs, and so forth. A depth node measures and enables an external effect to come into the instigate artificial intelligence natural language processing module 310 and provide control over just how “deep” the transition journey towards. An individual depth node may be a particular point in the conversation where the depth is measured, so it may be trained (captured) and recreated later. The conversation weighting module 338 may be configured to weigh and prioritize an individual statement or response in a conversation. The prioritization setting and choice may be determined based upon the various aspects, attributes, and status of the conversation. Each domain of language, sentence category or context may have its unique design which then influences the prioritization. The conversation weighting module 338 may be configured to utilize the weighing decisions to swap in different conversational engines. The conversation weighting module 338 may be configured to apply weighting to each kind of response to produce the best answer. The weighing attributes may affect the weighting of the response. The weighting attributes may include, but not limited to, morals, ethics, empathy, personality styles, real-life patterns, and so forth.

Referring to FIG. 3B, FIG. 3B is a block diagram 300b depicting the instigate artificial intelligence conversation management module, in accordance with one or more exemplary embodiments. The instigate artificial intelligence conversation management module 302 includes the pre-processing module 308, the internal NLP engine 310, and the external NLP engines 304. The pre-processing module 308 may be configured to check each and every input text response the user has typed as and routes that input text response to one of internal NLP engine 310 and the external NLP engines 304. The external NLP engines 304 (voice activated as well as text-based messaging systems) may include, but not limited to, Alexa, Google Asst, Bixby, Cortana, Hugging Face, Rasa, and the like.

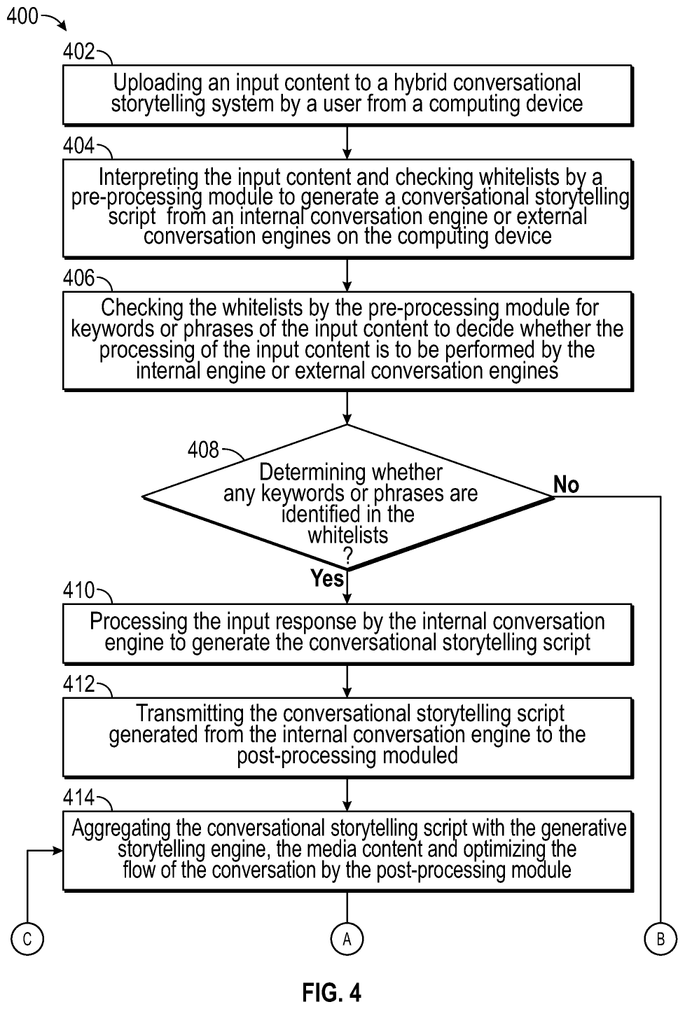

Referring to FIG. 4, FIG. 4 is a flow diagram 400 depicting a method for processing the input content to generate output response, in accordance with one or more embodiments. Method 400 may be carried out in the context of the details of FIGS. 1-4. However, method 400 may also be carried out in any desired environment. Further, the aforementioned definitions may equally apply to the description below.

The method commences at step 402, uploading the input content to the hybrid conversational storytelling system by the Instigator from the Instigator computing device. Thereafter at step 404, interpreting the input content and checking a plurality of whitelists by a pre-processing module to generate a conversational storytelling script from at least one of an internal conversation engine and a plurality of external conversation engines on the computing device. Thereafter at step 406, checking the whitelists by the pre-processing module for keywords or phrases of the input content to decide whether the processing of the input content is to be performed by the internal engine or external conversation engines. Determining whether any keywords or phrases are identified in the whitelists, at step 408. If the answer to step 408 is YES, processing the input response by the internal engine to generate the conversational storytelling script, at step 410. Thereafter at step 412, transmitting the conversational storytelling script generated from the internal conversation engine to the post-processing module. Thereafter, at step 414, aggregating the conversational storytelling script with the generative storytelling engine and the media content and optimizing the flow of the conversation by the post-processing module. Where the conversational storytelling script is generated from either the internal conversation engine or the plurality of external conversation engines. Thereafter at step 416, generating the media based conversational storytelling script on the Interactor's computing device. If the answer to step 408 is NO, processing the input content by the external conversation engines to generate the conversational storytelling script, at step 418. Thereafter at step 420, transmitting the conversational storytelling script generated from the external conversation engines to the post-processing module. Thereafter the method continues at step 414.

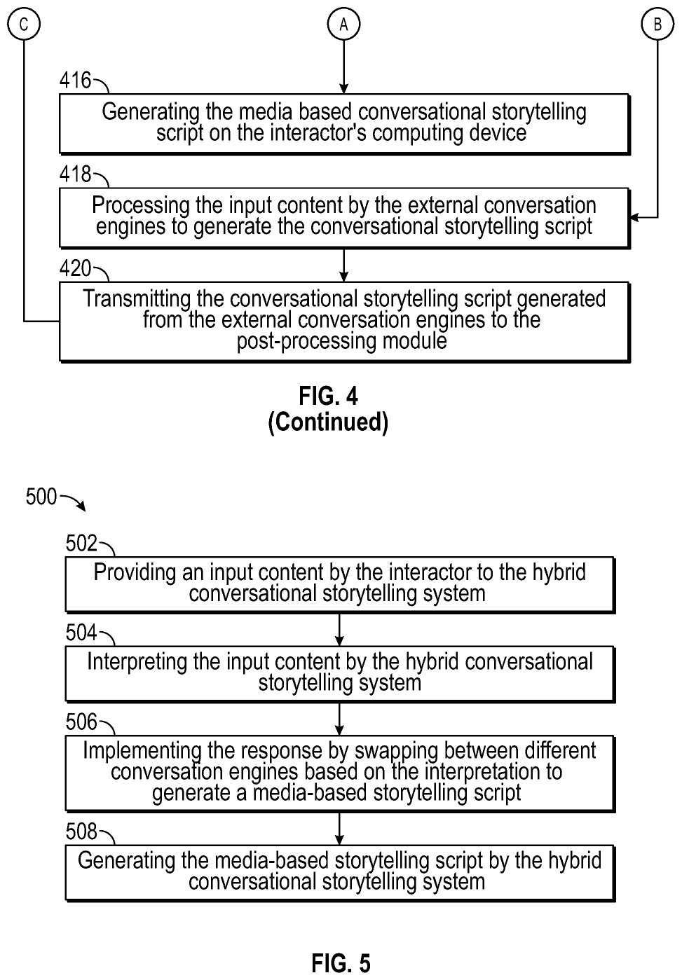

Referring to FIG. 5, FIG. 5 is a flow diagram 500 depicting a method for interpreting Interactor's conversation sequence and generating the response, in accordance with one or more embodiments. Method 500 may be carried out in the context of the details of FIGS. 1-4. However, method 500 may also be carried out in any desired environment. Further, the aforementioned definitions may equally apply to the description below.

The method commences at step 502, the input content may be provided by the Interactor to the hybrid conversational storytelling system. Here, the input content may include, but not limited to, a selfie video content, an audio content, an image, a data file, and the like. Thereafter, at step 504, the provided input content may be interpreted by the hybrid conversational storytelling system. Thereafter, at step 506, the response may be implemented by swapping between different conversation engines based on the interpretation by the hybrid conversational storytelling system to generate a media-based storytelling script. Thereafter, at step 508, the response may be generated by the hybrid conversational storytelling system.

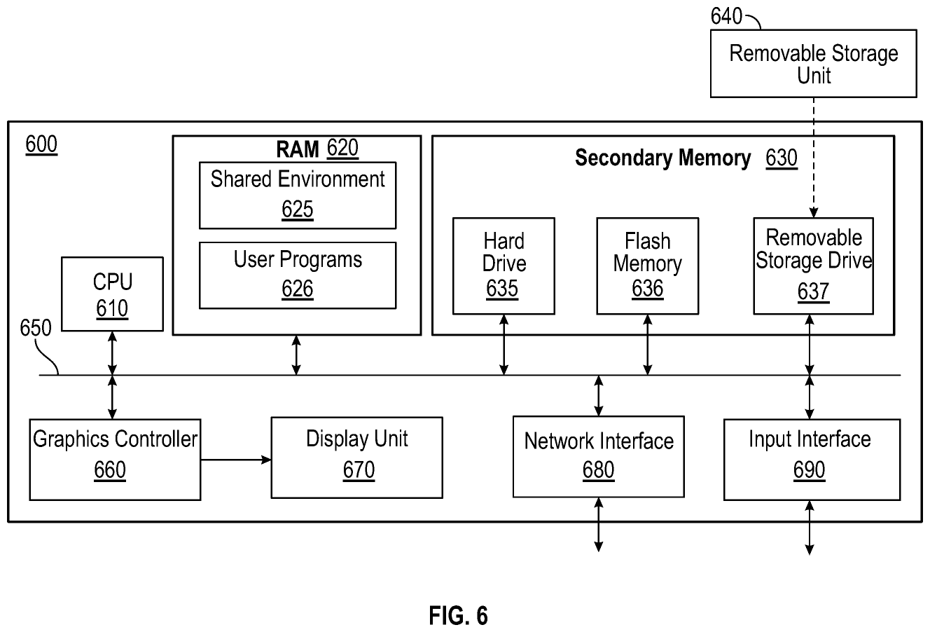

Referring to FIG. 6, FIG. 6 is a block diagram 600 illustrating the details of a digital processing system 600 in which various aspects of the present disclosure are operative by execution of appropriate software instructions. The Digital processing system 600 may correspond to computing devices 104-106 (or any other system in which the various features disclosed above can be implemented).

Digital processing system 600 may contain one or more processors such as a central processing unit (CPU) 610, random access memory (RAM) 620, secondary memory 627, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 710 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions, such as those used in threads and stacks, constituting shared environment 625 and/or user programs 626. Shared environment 625 includes operating systems, device drivers, virtual machines, etc., which provide a (common) nm time environment for execution of user programs 626.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (such as those shown in FIG. 1, network 108) connected to the network.

Secondary memory 630 may contain hard drive 635, flash memory 636, and removable storage drive 637. Secondary memory 630 may store the data software instructions (e.g., for performing the actions noted above with respect to the Figures), which enable digital processing system 600 to provide several features in accordance with the present disclosure.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EEPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 630. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Amendments and edits to the above-referenced disclosure is made via the Annexure herein. The disclosure set out in the Annexure hereto forms an integral part of this Specification and in the event of any conflict or discrepancy between the disclosure in the Specification and in the Annexure, the disclosure in the Annexure shall prevail.

What is claimed is:

1. A system for performing semantical analysis, generating contextually relevant, and topic based conversational storytelling through natural language processing techniques, comprising:
a hybrid conversational storytelling system comprising an instigate artificial intelligence conversation management module, a topic managing module, a context managing module, an internal conversation engine, and a plurality of external conversation engines, wherein the instigate artificial intelligence conversation management module is configured to execute a plurality of scripts, orchestrates media sequences within a conversation and analyse an input content received from a computing device, the instigate artificial intelligence conversation management module comprising a pre-processing module configured to interpret the input content and check a plurality of whitelists to generate a conversational storytelling script from at least one of an internal conversation engine and the plurality of external conversation engines on the computing device, the instigate artificial intelligence conversation management module is configured to transmit the conversational storytelling script generated from the at least one of the internal conversation engine and the plurality of external conversation engines to a post-processing module, whereby the post-processing module is configured to aggregate the conversational storytelling script with a generative storytelling engine and a media content to generate a media-based conversational storytelling script on the computing device, the conversational storytelling script is generated from at least one of the internal conversation engine and the plurality of external conversation engines.

2. The system of claim 1, wherein the hybrid conversational storytelling system is configured to integrate a plurality of relevant concepts, a plurality of events, people, a plurality of places and things into the conversation on the computing device.

3. The system of claim 1, wherein the instigate artificial intelligence conversation management module is configured to swap between the plurality of external conversation engines to generate the conversational storytelling script.

4. The system of claim 1, wherein the context managing module is configured to keep track of a current conversation, a backstory, semantics and current status on the computing device.

5. The system of claim 1, wherein the topic managing module is configured to collect, aggregate and support building semantically encoded storytelling proxy.

6. The system of claim 1, wherein the internal conversation engine comprising a conversation state module configured to keep track of the relevant content and topic-based attributes on the computing device.

7. The system of claim 1, wherein the internal conversation engine comprising a topic-based flow processing module configured to direct the conversation to various kinds of fall-backs and depth nodes on the computing device.

8. The system of claim 1, wherein the internal conversation engine comprising a conversation weighing module configured to weigh and prioritize an individual statement in the conversation on the computing device.

9. The system of claim 1, wherein the hybrid conversational storytelling system comprising a generative storytelling engine configured to generate a plurality of text paragraphs and conversations based on a pre-defined corpus of the input content.

10. The system of claim 1, wherein the pre-processing module is configured to check the input content that a user has typed and routes that input content to one of the at least one internal conversation engine and the plurality of external conversation engines.

11. The system of claim 1, wherein the post-processing module configured to optimize flow of the conversation on the computing device.

12. A method for interpreting an Interactor's conversation sequence and generating a response, comprising:
uploading an input content to a hybrid conversational storytelling system by a user from a computing device;
interpreting the input content and checking a plurality of whitelists by a pre-processing module to generate a conversational storytelling script from at least one of an internal conversation engine and a plurality of external conversation engines on the computing device;
transmitting the conversational storytelling script generated from at least one of the internal conversation engine and the plurality of external conversation engines to a post-processing module;
aggregating the conversational storytelling script with a generative storytelling engine and a media content and optimizing flow of the conversation by the post-processing module, whereby the conversational storytelling script is generated from the at least one of the internal conversation engine, the plurality of external conversation engines; and
generating a media-based conversational storytelling script on the computing device.

13. A computer program product comprising a non-transitory computer-readable medium having a computer-readable program code embodied therein to be executed by one or more processors, said program code including instructions to:
upload an input content to a hybrid conversational storytelling system by a user from a computing device;
interpret the input content and check a plurality of whitelists by a pre-processing module to generate a conversational storytelling script from at least one of an internal conversation engine and a plurality of external conversation engines on the computing device;
transmit the conversational storytelling script generated from the at least one of the internal conversation engine and the plurality of external conversation engines to a post-processing module;
aggregate the conversational storytelling script with a generative storytelling engine and a media content and optimizing flow of the conversation by the post-processing module, whereby the conversational storytelling script is generated from at least one of the internal conversation engine and the plurality of external conversation engines; and
generate a media-based conversational storytelling script on the computing device.

14. The computer program product of claim 13, wherein the hybrid conversational storytelling system comprising a conversation flow processing module configured to track a status of current conversation on the computing device.

15. The computer program product of claim 13, wherein the hybrid conversational storytelling system comprising a backstories module configured to track the backstories in the topics on the computing device.

16. The computer program product of claim 13, wherein the hybrid conversational storytelling system comprising an audio recognizing module configured to digitize and transcribe a speech into text.

17. The computer program product of claim 13, wherein the hybrid conversational storytelling system comprising an image recognition module configured to identify, label, output topics which reside within the visual frame of the media on computing device.
